(19) United States
(12) Patent Application Publication
(10) Pub. No.: US 2017/0341417 A1
(43) Pub. Date: Nov. 30, 2017

(54) FLEXIBLE, MODULAR ARCHITECTURE FOR A DIGITAL PRINTER

(71) Applicant: XEROX CORPORATION, NORWALK, CT (US)

(72) Inventor: Jean-Michel Fouet, La Ciotat (FR)

(21) Appl. No.: 15/424,956

(22) Filed: Feb. 6, 2017

Related U.S. Application Data
(60) Provisional application No. 62/341,244, filed on May 25, 2016.

(51) Int. Cl. B41J 11/00

(52) U.S. Cl. CPC B41J 11/002

(57) ABSTRACT

A printing apparatus provides a printing path disposed along one level, the printing path having a first portion and second portion, each portion having a printhead associated therewith. The apparatus further includes a drying path along a second level, the drying path including two dryer modules. In one arrangement in which the apparatus can operate, a sheet path provides for printing in the first portion of the print path, drying in the first drying module, printing on the second side of a sheet in the second portion of the sheet path, and drying in the second drying module. In another arrangement in which the apparatus can operate, a sheet path can provide for printing in either or both portions of the sheet path, followed by drying in one or both drying modules and then exit from the apparatus, such as to a second apparatus. The architecture enables the apparatus to function by itself or as part of a multi-apparatus printing system.

### CLAIM OF PRIORITY FROM PROVISIONAL APPLICATION

The present application claims priority from U.S. Provisional Application Ser. No. 62/341,244, filed May 25, 2016.

### TECHNICAL FIELD

The present disclosure relates to an architecture for a digital printer, such as a full-width ink-jet printer, that is suitable for modular configurations.

### BACKGROUND

Large-scale digital printers, such as printers with full-width ink-jet printheads printing on continuously-fed webs, represent a major capital expenditure for print shops. It is therefore desirable to provide a printer architecture that can be readily adapted for specific print job requirements.

### SUMMARY

According to one aspect, there is provided a printing apparatus, comprising a printing path disposed along a first level, the printing path defining a first portion having a first printhead associated therewith, and a second portion having a second printhead associated therewith. A drying path, including a first dryer module and a second dryer module, is disposed along a second level. A return path is disposed along a third level, the return path being configured to convey a sheet passing to the left from the drying path to the right through the return path. A sheet can be selectably caused to be fed in one of (a) a first arrangement, whereby a sheet is fed to the right through the first portion of the printing path, to the left through the first drying module, through at least a portion of the return path, through the left through the second portion of the printing path, and to the right through the second drying module, and (b) a second arrangement, whereby a sheet is fed to the right through at least the first portion of the printing path, to the left through at least the first drying module, and then out of the printing apparatus.

According to another aspect, there is provided a printing system having a first printing apparatus and a second printing apparatus, with a sheet being capable of being fed from the first printing apparatus to the second printing apparatus. Each printing apparatus comprises a printing path disposed along a first level, the printing path defining at least a first portion having a first printhead associated therewith, and a drying path, including at least a first dryer module, the drying path being disposed along a second level. A sheet may be fed in a first arrangement wherein a sheet is fed to the right in the printing path of the first printing apparatus, then to the left in the drying path of the first printing apparatus, to the left in the printing path of the second printing apparatus, then to the right in the drying path of the second printing apparatus. Alternatively, a sheet may be fed in a second arrangement wherein a sheet is fed to the right in the printing path of the first printing apparatus, then to the left in the drying path of the first printing apparatus, to the right in the printing path of the second printing apparatus, then to the left in the drying path of the second printing apparatus.

### BRIEF DESCRIPTION OF THE DRAWINGS

FIG. 1 is an elevational view of a printing apparatus with an example sheet path.

FIG. 2 is an elevational view of a printing apparatus, similar to that of FIG. 1, but with an extension added.

FIGS. 3-8 are elevational views showing a series of alternative arrangements involving a printing system including two printing apparatuses.

### DETAILED DESCRIPTION

In the following description and claims, the following definitions and other comments shall apply:

Although the description and claims mention “to the right” and “to the left” motion of sheets or web, these directions are stated for purposes of clarity only. The claims are intended to encompass embodiments that are in effect mirror images of the Description and Claims, where right is left and vice-versa.

As used herein, a “path” is a configuration of hardware and/or software controls, including rollers, guides, motors, etc. as needed, to permit conveyance of a sheet through a desired path.

As used herein, “sheet” shall include any substrate on which images are desired to be printed, regardless of material composition (e.g., paper, plastic), and, unless otherwise specified, regardless of whether the sheet is in the form of cut sheets or a continuous web.

As used herein, a “printhead” shall be defined as any hardware useful in placing a desired image (or partial image, such as a single color separation of an intended multicolor image) on a sheet. The word “printhead” can refer to multiple printheads functioning together. In a typical embodiment, a printhead includes at least one ink-jet printhead, emitting liquid ink in imagewise fashion onto a sheet; in another common embodiment, a printhead can include a transfer roll, transfer belt, or photoreceptor, such as used in electrostatic or xerographic printing.

As used herein, a “dryer” or “drying module” shall be defined as any hardware that provides energy, such as radiant heat, convective heat, ultraviolet light, etc., to a sheet or to an image or partial image placed on a sheet at any point in an overall printing process. Also, the action of a dryer or drying module (“drying”) shall also include curing of ink or other marking material, or causing any other chemical reaction in ink or other marking material. When it is stated that a sheet is caused to move “through” a dryer or drying module, it is meant the sheet is placed relative to the dryer or drying module in such a way that the dryer or drying module influences (such as by heating, drying, or curing) the ink or other marking material and/or the sheet itself. Such influencing can occur before or after any image or partial image is placed on the paper, i.e., includes pre-heating or pre-treating.

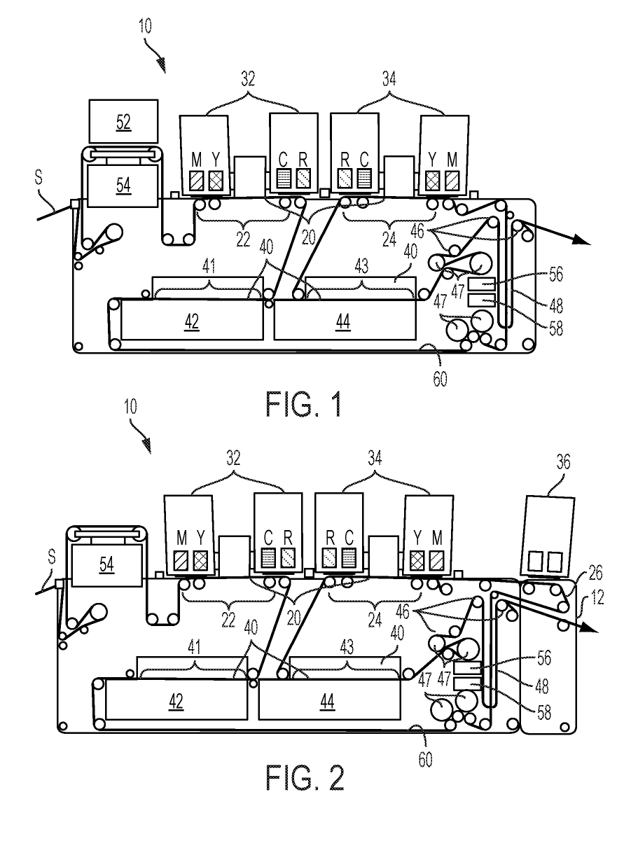

FIG. 1 is an elevational view of a printing apparatus 10 with an example sheet path, the overall direction of which is indicated by the sheet S, which is in this embodiment in the form of a continuous web. The overall architecture of the apparatus defines three general paths: a printing path, generally indicated as 20; a drying path, generally indicated as 40; and a return path, generally indicated as 60. Each path 20, 40, 60 can be seen as disposed on a different level, with printing path 20 being disposed above drying path 40, and drying path 40 being disposed above return path 60 in this embodiment.

In FIG. 1, printing path 20 defines a first portion 22 and a second portion 24, collinear therewith. As shown, associated with first portion 22 is a printhead 32, and associated with second portion 24 is a printhead 34. As shown, each printhead 32, 34 includes a plurality of printheads, each printhead providing a color separation C, M, Y, K, as is familiar in digital printing, so that each printhead 32, 34 is capable of placing a full-color or multi-color image on the sheet S as it passes thereby. (As shown in all the Figures, each primary color is indicated with a unique cross-hatch pattern; these patterns shall apply to all Figures.) The hardware within apparatus 10, such as with rollers, guides and controllable motors (not shown), can readily cause a sheet S to pass through either printing module in either direction (to the left or to the right), of course depending on modifications to the image data driving either printhead under a given arrangement.

Drying path 40 includes two portions, 41, 43, corresponding to two drying modules 42, 44, of any type as defined above. The drying modules are designed so that sheet S can pass through either drying module in either direction (to the left or to the right) depending on the overall operation of the apparatus 10. In one embodiment, the drying modules 40, 42 are readily removable from the bulk of apparatus 10, and are positionally interchangeable, i.e., have the same outer dimensions and same electrical contact locations (not shown).

Other hardware that can be found in an embodiment includes a web cleaner 52, a web guide 54, and image sensors 56, 58, which, as shown, are disposed relative to an arrangement of rollers to be able to inspect images on either side of the printed sheet as needed.

Following the path of sheet S in FIG. 1, it can be seen that sheet S is fed to the right through the first portion 22 of the printing path 20, to the left through the drying module 42, and then along return path 60; sheet S then moves through the left through the second portion 24 of the printing path 20, and to the right through the drying module 44. In this configuration, sheet S is inverted between the two printing steps, so that one side of sheet S is printed upon by printhead 32, and then dried by drying module 42; and then the other side of sheet S is printed upon by printhead 34, and then dried by drying module 44; the final result being a sheet printed with full-color images on both sides. As shown, each printed side of the sheet S can be brought near image sensor 56 and/or 58 for image quality inspection. After moving through drying module 44, the sheet S can be sent through an arrangement of rollers generally indicated as 46 out of the printing apparatus 10. There may further be provided a set of cooling rollers 47 associated with the sheet S, which in some implementations will be useful for image-quality purposes, such as to cool the sheet S between printing operations in portions 22 and 24.

As shown in FIG. 1 the arrangement of rollers 46 causes a steep buckle 48 in sheet S: in this particular embodiment, the induced buckle 48 enables the outgoing portion of sheet S to be steered around the portion of sheet S that is simultaneously moving from return path 60 upward to second portion 24 of the printing path 20. Although a buckle is generally shown, the effect of one portion of the web-sheet S avoiding another portion can be carried out by an arrangement of turnbars (not shown), in a manner familiar in the sheet-feeding art.

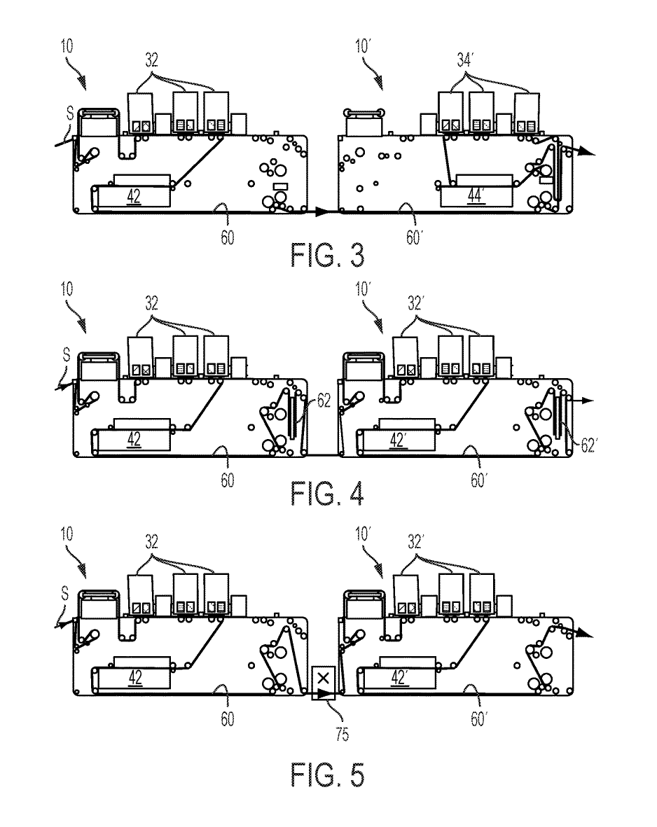

The arrangement of the path formed by sheet S in FIG. 1 is only one possible arrangement that can be manifest using the basic hardware (and control software) shown in FIG. 1. The architecture of the printing apparatus 10 is suitable for modular adaptation. For example, FIG. 2 shows the same hardware as in FIG. 1, with the addition of an extension module 12. The extension module 12 includes a printhead 36 that prints on sheet S in a location representing, in effect, an extension of second portion 24 of printing path 20—the printhead 36 prints on the same side of sheet S as printhead 34. In a practical embodiment, extra printhead 36 could be a printhead that provides a dedicated spot color often used by a customer, or a magnetic-based MICR ink for check printing.

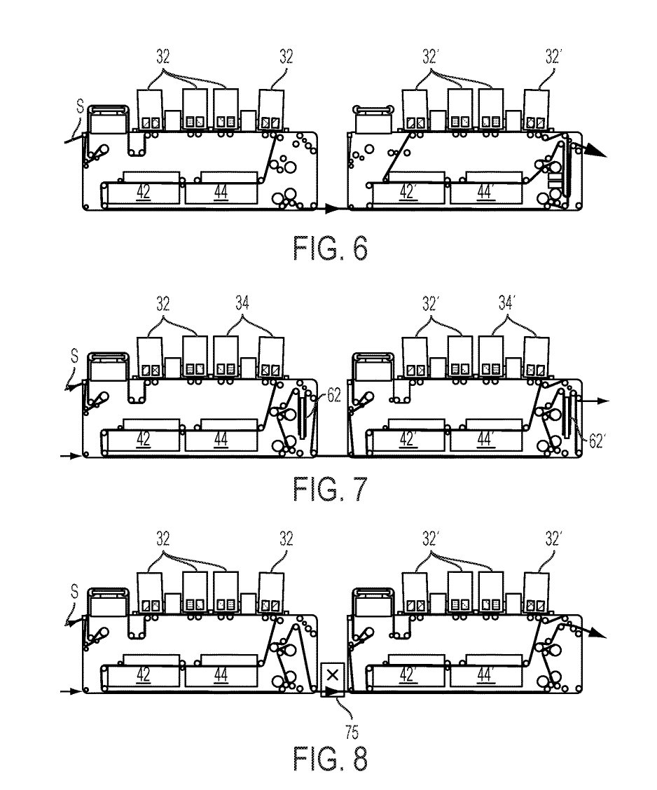

The basic hardware of apparatus 10 shown in FIG. 1 is further conducive to be coordinated with a second apparatus, substantially similar in hardware arrangement. FIGS. 3-8 show a series of alternate arrangements of a printing system having two apparatuses, here indicated as 10 and 10′ (as described therein, all reference numbers with a prime symbol refer to a structure in apparatus 10′). In an embodiment, the two apparatuses 10 and 10′ are similar in design, and differ only the by the operation of motors and other hardware directing a sheet S, here shown in the form of a continuous web, therethrough. The coordinated operation of apparatuses 10 and 10′ can be performed by a common control system (not shown) which will also control the image data being sent to the various printheads to print desired images. In either printing apparatus 10 or 10′, the associated print path having printheads such as 32′ or 34′ associated therewith can be capable of printing a full-color, or more broadly multi-color, image on a side of the sheet S.

In the FIG. 3 arrangement, the sheet S enters first apparatus 10, where it is moved to the right and printed upon by printhead 32, then moved to the left through drying module 42, and sent through return path 60; the sheet S then exits apparatus 10, and enters return path 60′ of apparatus 10′. The sheet S is then moved to the left past printheads 34′ and then to the right through drying module 44′, where it is then fed out of apparatus 10′. As can be seen, the basic arrangement of the single apparatus 10 shown in FIG. 1 is effectively spread over apparatuses 10 and 10′ in FIG. 3; however this extension enables more printheads or other printer hardware in printhead 32 and 34′ compared to the single module of FIG. 1, thus enabling more primary colors to be printed, enabling a faster print speed, or otherwise enhancing print quality.

In the FIG. 4 arrangement, the sheet S is first moved to the right past printhead 32; then moved to the left through drying module 42; moved to the right through return path 60; and then inverted by means of a turnbar arrangement 62 of a type generally known in the art. One example of a turnbar arrangement, especially suited for web printing, is taught in U.S. Pat. No. 8,992,004. The inverted sheet S then exits apparatus 10, and enters apparatus 10′ where it is moved to the right to be printed upon by printhead 32′ and then moved to the left through drying module 42′. Because the sheet S was inverted by turnbar arrangement 62 before entering apparatus 10′, the opposite side of the sheet S is printed upon in apparatus 10′ than in apparatus 10′. The sheet S can then be re-inverted by a turnbar arrangement 62′ in apparatus 10′, so that the first side printed in apparatus 10 will again be facing upward at the end of the process. Once again, by spreading the printing process over two apparatuses 10 and 10′, more colors, greater speed, etc., is enabled.

In the FIG. 5 arrangement, the sheet S enters first apparatus 10, where it is moved to the right and printed upon by printhead 32, then moved to the left through drying module 42, and sent through return path 60; the sheet S then exits apparatus 10, and enters apparatus 10′ where it is moved to the right to be printed upon by printhead 32′ and then moved to the left through drying module 42′. Interposed between apparatuses 10 and 10′ is a turnbar system or other inverter 75, of a type generally known in the art, which inverts sheet S so the side of sheet S opposite that printed upon by printhead 32 is printed upon by printhead 32′, yielding a sheet printed upon on both sides. This extension enables more printheads or other printer hardware in printhead 32 and 32′ compared to the single module of FIG. 1, thus enabling more primary colors to be printed, or otherwise enhancing print quality. One example of a turnbar arrangement for inverter 75, especially suited for web printing, is taught in U.S. Pat. No. 8,992,004.

In the FIG. 6 arrangement, the sheet S enters first apparatus 10, where it is moved to the right and printed upon by printheads 32 (i.e., through portions 22 and 24 of print path 20, as shown in FIG. 1), then moved to the left through drying modules 42 and 44, and sent through return path 60; the sheet S then exits apparatus 10, and enters return path 60′ of apparatus 10′. The sheet S is then moved to the left past printheads 32′ and then to the right through drying modules 42′ and 44′, where it is then fed out of apparatus 10′. As can be seen, the basic arrangement of the single apparatus 10 shown in FIG. 1 is effectively spread over apparatuses 10 and 10′; however this extension enables more printheads or other printer hardware in printheads 32 and 34′ compared to the single module of FIG. 1; and further enables multiple drying modules 42 and 44, 42′ and 44′, to be used immediately after printing in each apparatus 10 or 10′ in case extra drying or other treatment is desired.

In the FIG. 7 arrangement, the sheet S is first moved to the right past printheads 32 and 34 (i.e., through portions 22 and 24 of print path 20, as shown in FIG. 1); then moved to the left through drying modules 42 and 44; moved to the right through return path 60; and then inverted by means of a turnbar arrangement 62 of a type generally known in the art. One example of a turnbar arrangement, especially suited for web printing, is taught is U.S. Pat. No. 8,992,004. The inverted sheet S then exits apparatus 10, and enters apparatus 10′ where it is moved to the right to be printed upon by printhead 32′ and 34′ (i.e., through portions 22 and 24 of print path 20, as shown in FIG. 1); and then moved to the left through drying modules 42′ and 44′. Because the sheet S was inverted by turnbar arrangement 62 in apparatus 10 before entering apparatus 10′, the opposite side of the sheet S is printed upon in apparatus 10′ than in apparatus 10. The sheet S can then be re-inverted by a turnbar arrangement 62′ in apparatus 10′, so that the first side printed in apparatus 10 will again be facing upward at the end of the process.

In the FIG. 8 arrangement, the sheet S enters first apparatus 10, where it is moved to the right and printed upon by printhead 32 (in this case, a set of four printheads operating together in each apparatus 10, 10′), then moved to the left through drying modules 42 and 44, and sent through return path 60; the sheet S then exits apparatus 10, and enters apparatus 10′ where it is moved to the right to be printed upon by printhead 32′ and then moved to the left through drying modules 42′ and 44′. Interposed between apparatuses 10 and 10′ is a turnbar system or other inverter 75, of a type generally known in the art, which inverts sheet S so the side of sheet S opposite that printed upon by printhead 32 is printed upon by printhead 32′, yielding a sheet printed upon on both sides. This extension enables more printheads or other printer hardware in printhead 32 and 32′ compared to the single module of FIG. 1; and further enables multiple drying modules 42 and 44, 42′ and 44′, to be used immediately after printing in each apparatus 10 or 10′ in case extra drying or other treatment is desired. One example of a turnbar arrangement for inverter 75, especially suited for web printing, is taught is U.S. Pat. No. 8,992,004.

The various combinations of apparatuses 10 and 10′ in FIGS. 3-8 can be summarized as follows. In one arrangement, such as in the FIG. 3 and FIG. 6 embodiments, the sheet S is fed to the right in the printing path and to the left in the drying path of printing apparatus 10, while the sheet S is then fed to the left in the printing path and to the right in the drying path of printing apparatus 10′. In another arrangement, such as in the FIGS. 4, 5, 7, and 8 embodiments, the sheet S is fed to the right in the printing path and to the left in the drying path of each printing apparatus 10 and 10′. In either printing apparatus 10 or 10′, the associated drying path can include one or more positionally interchangeable dryer modules such as 42, 44, 42′, 44′, as needed to obtain a desired print quality or other metric.

In overview, the basic design of apparatus 10 enables flexible operation by itself, simply by threading the web sheet S through the apparatus 10 in a particular manner, such as shown in FIG. 1, and controlling the associated motors and image software accordingly. (In a sheet-fed implementation, not shown, paper guides and other hardware could be controlled and positioned to obtain a desired overall sheet path.) Two apparatuses 10 and 10′ can also be combined and operate effectively as one, to obtain higher speed, more colors, more effective drying, etc., as needed, once again by threading the web sheet S as needed and controlling the hardware and image software accordingly, such as on a job-by-job basis.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A printing apparatus, comprising:
a printing path disposed along a first level, the printing path defining a first portion having a first printhead associated therewith, and a second portion having a second printhead associated therewith;
a drying path, including a first dryer module and a second dryer module, the drying path being disposed along a second level;
a return path disposed along a third level, the return path being configured to convey a sheet passing to the left from the drying path to the right through the return path;
whereby a sheet can be fed in one of:
(a) a first arrangement, whereby a sheet is fed to the right through the first portion of the printing path, to the left through the first drying module, through at least a portion of the return path, through the left through the second portion of the printing path, and to the right through the second drying module, and
(b) a second arrangement, whereby a sheet is fed to the right through at least the first portion of the printing path, and to the left through at least the first drying module, and then out of the printing apparatus.

2. The apparatus of claim 1, wherein the first printhead and second printhead are each capable of placing a multi-color image on the sheet.

3. The apparatus of claim 1, the second level being disposed below the first level.

4. The apparatus of claim 1, wherein the first portion of the printing path and the second portion of the printing path are collinear.

5. The apparatus of claim 1, whereby, in the second arrangement, the sheet is fed in series through the second drying module and the first drying module.

6. The apparatus of claim 1, wherein the first drying module and the second drying module are positionally interchangeable.

7. The apparatus of claim 1, further comprising an extension module, the extension module including an extension to the second portion of the printing path, and a printhead that prints on a sheet passing through the extension.

8. The apparatus of claim 1, further comprising an inverter operatively disposed along the return path, the inverter inverting a sheet being fed out of the apparatus.

9. A printing system having a first printing apparatus and a second printing apparatus, whereby a sheet is fed from the first printing apparatus to the second printing apparatus, each printing apparatus comprising:
a printing path disposed along a first level, the printing path defining at least a first portion having a first printhead associated therewith, and
a drying path, including at least a first dryer module, the drying path being disposed along a second level;
wherein a sheet may be fed in one of:
(a) a first arrangement wherein a sheet is fed to the right in the printing path of the first printing apparatus, then to the left in the drying path of the first printing apparatus, to the left in the printing path of the second printing apparatus, then to the right in the drying path of the second printing apparatus, or
(b) a second arrangement wherein a sheet is fed to the right in the printing path of the first printing apparatus, then to the left in the drying path of the first printing apparatus, to the right in the printing path of the second printing apparatus, then to the left in the drying path of the second printing apparatus.

10. The printing system of claim 9, further comprising an inverter operatively disposed between the first printing apparatus to the second printing apparatus.

11. The printing system of claim 9, further comprising an inverter operatively disposed after the second printing apparatus.

12. The printing system of claim 9, wherein the printing path of the first printing apparatus is capable of printing a multi-color image on the sheet.

13. The printing system of claim 9, wherein the printing path of the first printing apparatus and the second printing apparatus is capable of printing a multi-color image on the sheet.

14. The printing system of claim 9, wherein the drying path of the first printing apparatus includes a plurality of dryer modules, wherein the drying modules are positionally interchangeable.

15. The printing system of claim 9, wherein the drying path of the first printing apparatus and the second printing apparatus includes a plurality of dryer modules, wherein the drying modules are positionally interchangeable.
